(19) United States
(12) Patent Application Publication
(10) Pub. No.: US 2014/0364171 A1
(43) Pub. Date: Dec. 11, 2014

(54) METHOD AND SYSTEM FOR IMPROVING VOICE COMMUNICATION EXPERIENCE IN MOBILE COMMUNICATION DEVICES

(71) Applicant: DSP Group, San Jose, CA (US)

(72) Inventors: Arie Heiman, Sde Warburg (IL); Uri Yehuday, Bat Yam (IL); Roei Roeimi, Hagor (IL)

(21) Appl. No.: 14/233,423

(22) PCT Filed: Feb. 25, 2013
(86) PCT No.: PCT/IL2013/050164

§ 371 Date: Jan. 17, 2014

Related U.S. Application Data
(60) Provisional application No. 61/605,287, filed on Mar. 1, 2012.

(51) Int. Cl. H04M 1/60

(52) U.S. Cl. CPC H04M 1/605
USPC 455/566

(57) ABSTRACT

A mobile communication device has a body that houses electronic components and a front panel comprising a display, said mobile communication device further comprising at least one standard microphone and a vibration sensor located in vibrational connection with the front panel of the device.

### FIELD OF THE INVENTION

The invention relates to the field of communication system. More specifically, the invention relates to voice communication enhancement in mobile devices using bone conduction phenomena.

### BACKGROUND

In the modern world voice communication by mobile devices is an integral part of a person's life. Voice enhancement technology is constantly advancing, and improved devices are developed all the time. However, voice communication in noisy environment is a challenge with which mobile have difficulty coping. In a noisy environment the microphone of a mobile communication device picks up a signal that combines the voice of the mobile phone user and the ambient noise. As a result, a low quality of voice is provided to the party at the other end of the line.

Typically mobile phone users use the phone either in speaker mode or in handheld mode, and in the latter there is direct contact between the speaker of the phone (also referred to as “ear piece speaker”) and the user's ear. Although speaker mode enables freer movement, most people use the speaker mode only in case that the environment is quite and there is little ambient noise or no ambient noise and, of course, other people are not around so that privacy can be maintained. However, in mid or high ambient noise most people prefer to use the handheld mode, in which the phone is in contact with one of their ears. This is due to the fact that in speaker mode the party with which the user is conversing hears a lot of ambient noise, and also the phone user cannot hear his party's voice clearly, because of the noise around him. Moreover, if the noise is high, many phone users attach the phone to one of their ears and simultaneously close the other ear with their hand, to reduce the amount of the ambient noise that they hear.

One option to improve transmitted voice quality uses noise reduction techniques (sometime also referred to as “noise cancellation techniques”) by using one or multiple microphones. Examples for some mobile phones that use two microphones are: iPhone 4 from Apple Inc. and Samsung's Galaxy S2. The noise reduction technique improves the transmitted voice call to some extent, however that is only a partial solution, since the user that is talking in the noisy environment still suffers from the ambient noise and in many cases the received voice from the other party is not heard well.

The use of bone conduction is known in the art, mainly as a solution for people who suffer from hearing impairment; in such mode the sound waves are transformed into vibrations and are transmitted to the inner ear through the skull bone. This technique is also used in the field of earpieces bone conduction, for example, as described in international patent application WO 2010/052720, which discloses an earpiece and a method for playing a stereo and a mono signal using a bone conduction speaker. Bone conduction speakers were also used in Kyocera's smartphone—Urbano Progresso, which employs exclusively bone conduction speakers. The use of bone conduction speakers requires a direct contact between the mobile phone speaker and in any point of the user's skull

In spite of many efforts made by many different manufacturers, there is still ample room and need for improvement of the quality of sounds transmitted and received between users of mobile communication devices, such as mobile phones, when at least one of the users in the communication is located in a noisy environment.

It is therefore an object of the present invention to provide a mobile communication device that provides improved transmitted voice quality when the user who speaks is found in a noisy environment.

It is another object of the invention to provide a mobile communication device equipped with a vibration detector, which permits to use the voice vibrations of the user without being adversely affected by the ambient noise.

It is yet another object of the present invention to provide a mobile device with a vibration detector which can be embedded as part of the panel of the mobile phone or behind said panel with a direct contact to it, regardless the exact location of the vibration detector.

It is yet another object of the present invention to provide a mobile device which automatically recognizes the mode of use of the mobile device and automatically adjusts the operation techniques and the noise reduction techniques to the mode of use of the mobile device.

It is a further object of the invention to provide a mobile device which provides a high quality voice perception to the user of the device in a high level noise environment.

Further purposes and advantages of this invention will become apparent as the description proceeds.

### SUMMARY OF THE INVENTION

In one aspect the invention relates to a mobile communication device having a body that houses electronic components and a front panel comprising a display, said mobile communication device further comprising at least one standard microphone and a vibration sensor located in vibrational connection with the front panel of the device. According to another embodiment of the invention the mobile communication device further comprises a bone conduction speaker.

Throughout this specification the terms “vibration detector”, “vibration sensor”, and “bone conduction microphone”, are used interchangeably.

According to one embodiment of the invention the vibration sensor is attached to the front panel, but in other embodiments it is located away from the front panel, as long as it is in vibrational connection with it.

In another aspect the invention is directed to a mobile communication device comprising a processor configured to operate differently as a result of a determination that the user of the mobile communication device is operating it in one of the following modes:
i) a “Speaker Mode” with the device far from the user's mouth;
ii) a “Speaker Mode” with the device close to the user's mouth;
iii) a “Handheld Mode” with the device in contact with one of the user's ear;
iv) a “Handheld Mode” with the device in contact with one of the user's ear while the second ear is closed.

Several different modes of operation are possible according to the invention, for instance: the mode is i) and the processor activates one or more standard microphones; or the mode is ii) or iii) and the processor activates two or more standard microphones located at two different locations in the communication device, and further operates a vibration detector positioned so as to detect vibration generated by the user's voice on the device's panel; or the mode is iv) and the processor activates two or more standard microphones, a vibration detector and a bone conduction speaker.

In one particular embodiment of the invention when the bone conducting speaker is activated the processor is configured to balance the signal transmitted to the ears so as to provide to the user a voice of approximately the same intensity in both ears.

As will be apparent to the skilled person, the invention provides many advantages so far unavailable in the art. For instance, it allows to provide an indicator suitable to alert the user that the phone is located at a distance from his mouth that is greater than a predetermined value. The indication can be provided, for example, by generating an acoustic signal or a visual signal.

As another example, the invention allows to provide a noise reduction indicator suitable to provide an indication to the user of the level of noise reduction that a conversation is enjoying.

In another aspect the invention is directed to a method for operating a mobile communication device having a body that houses electronic components and a front panel comprising a display, said mobile communication device further comprising at least one standard microphone and a vibration sensor located in vibrational connection with the front panel of the device, the method comprising providing a processor configured to operate differently as a result of a determination that the user of the mobile communication device is operating it in one of the following modes:
i) a “Speaker Mode” with the device far from the user's mouth;
ii) a “Speaker Mode” with the device close to the user's mouth;
iii) a “Handheld Mode” with the device in contact with one of the user's ear;
iv) a “Handheld Mode” with the device in contact with one of the user's ear while the second ear is closed.

As will be apparent to the skilled person, and as will be further discussed in the description to follow, the above and other options offered by the invention significantly improve the quality and the user's experience during communication, particularly when taking place in noisy environments.

All the above and other characteristics and advantages of the invention will be further understood through the following illustrative and non-limitative description of embodiments thereof, with reference to the appended drawings. In the drawings the same numerals are sometimes used to indicate the same elements in different drawings.

### BRIEF DESCRIPTION OF THE DRAWINGS

FIG. 1 schematically shows a speaker mode, where the mobile device is held at a large distance from the user's mouth;

FIG. 2 schematically shows a speaker mode, where the mobile device is held at a relatively close distance from the user's mouth;

FIG. 3 schematically shows a handheld mode, where the mobile device is held so that there is direct contact between the device and the user's ear;

FIG. 4 schematically shows a handheld mode, where the mobile device is held so that there is direct contact between the device and the user's ear, and simultaneously the other ear is closed by the user;

FIG. 5 schematically shows a mobile device panel with a vibration detector according to an embodiment of the invention;

FIG. 6 (A and B) shows an example according to an embodiment of the invention, where the mobile device is held so that there is one point of direct contact between the device and the user's skull;

FIG. 7 shows an example according to an embodiment of the invention, where the mobile device is held so that there is direct contact between the device and the user's skull;

FIG. 8 schematically shows the structure of the mobile device according to an embodiment of the invention;

FIG. 9 is a schematic flow chart of the method of the invention according to an embodiment of the invention; and

FIG. 10 schematically describes the system which estimates the original speech s(n) and the ambient noise d(n); and

FIG. 11 shows a schematic flow chart which describes an example of a speech detection mechanism.

### DETAILED DESCRIPTION OF EMBODIMENTS OF THE INVENTION

The present invention relates to a noise reduction system and apparatus that improve the transmitted voice quality in noisy environment, and improves the perception of the incoming call by taking into consideration the different modes of use by phone users in noisy environments. In the present invention different processes are performed for each mode of use, and thus full advantage is taken of the various capabilities offered by different modes of use. According to the invention multi standard microphones and bone conduction microphones (also referred to as “bone vibration detector”) are used in the mobile communication device, as well as bone conduction speakers and a processor.

Throughout this description the terms “phone”, “mobile communication device”, and the like terms, are used interchangeably and no term is meant to introduce any limitation of any kind to the particular nature, shape or elements of a device to which invention is directed. The skilled person will easily understood from this description which mobile communication devices can benefit from the invention, which includes not only cellular devices, but also any other kind of mobile equipment, such as Wi-Fi and radio apparatus, regardless of the medium over which the transmission takes place.

The processor is configured according to the invention to automatically analyse the mode of operation of the mobile phone and automatically performs a different process adjusted to each mode, by taking advantage of bone conduction microphones, bone conduction speakers, as appropriate under the specific operating conditions, as will be further elaborated below. The processor is configured to recognize the mode of operation of the mobile phone and automatically switches between the different modes of operation to reduce the effect of the ambient noise.

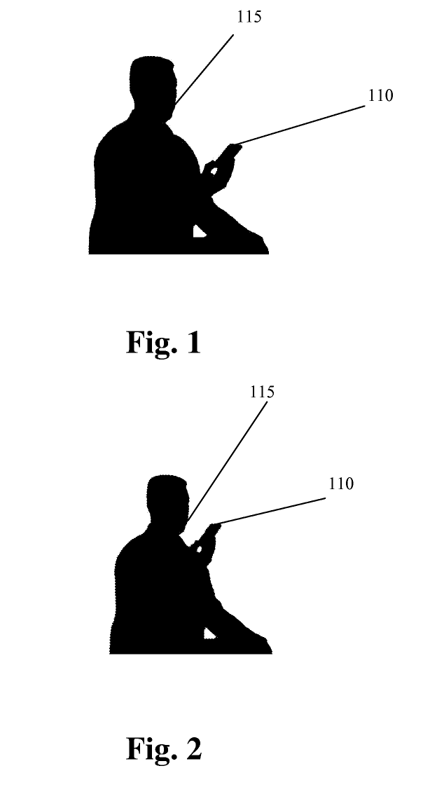

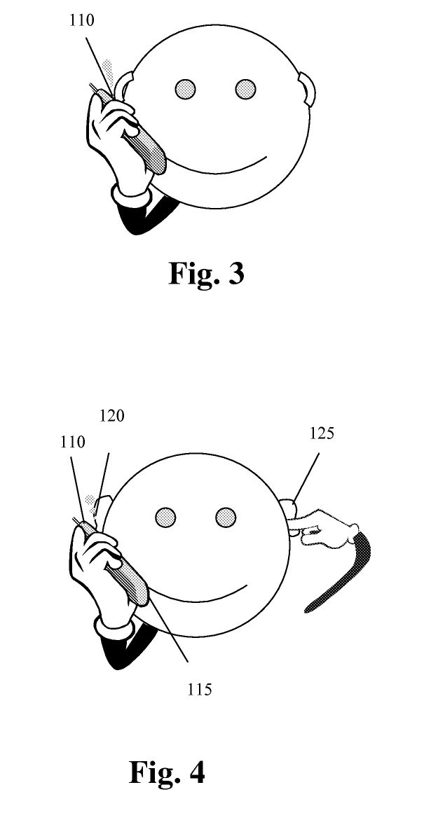

In one embodiment of the invention, four main operation modes are defined. Each mode is typically used in a different ambient noise scenario, and is briefly described below with reference to the figures:
Quiet Mode: FIG. 1 schematically shows a speaker mode where the mobile device is held at a relatively large distance (e.g., more than ˜30 cm) from the user's mouth. This speaker mode is typically used in the range between a zero level of ambient noise to a low level of ambient noise. In this case the user speaks in speaker mode, namely the mobile phone 110 is far from the user's mouth 115 and the user hears the received voice via the speaker of the phone.
Low Noise: FIG. 2 schematically shows a speaker mode where the mobile phone 110 is held at a relatively close distance (e.g., below ˜30 cm) from the user's mouth 115; In this case the user speaks in speaker mode but he holds the phone close to his mouth in order to overcome the environmental noise and be able to hear the incoming call via the speaker of the mobile phone.
Any Noise: FIG. 3 schematically shows a handheld mode where there is a at least one point of a direct contact between the mobile phone 110 and the user's ear. This mode of operation is considered to be the regular mode of operation of the mobile phone as it can be used in any level of ambient noise and it is the most common mode of use. Yet, for a situation of an ambient noise level in the range of mid to high noise level, this mode of use is the most suitable in order to increase the incoming sound level as well as to increase the voice level of the user relative to the ambient noise level, in order to reduce the noise effect for the other party; and
High Noise: FIG. 4 schematically shows a handheld mode, where the mobile phone 110 is held so that there is a direct contact between the phone and the user's ear 120, and simultaneously the other ear 125 is closed by the user to reduce the effect of the ambient noise he hears. This mode is used when there is a high level of ambient noise.

Mobile phone users prefer to use the speaker during voice call (the “speaker mode”). The use of speaker mode has a big advantage as it doesn't force the user to have a contact between the phone and his ear and is normally considered to be healthier because the distance is maintained between the user's head and the phones antenna. In addition for voice command or voice search applications such as SIRI from Apple Inc. or Google now, users want to view the feedback to their command or question that the application provides, hence they are holding the phone in front of their face.

However, the use of speaker mode introduces some challenges. One of the problems is echo, namely, the microphone of the mobile devices “hears” also the speaker and retransmitted it to the far end user where he hears himself as an echo. To reduce the echo effect standard adaptive echo cancellation technique can be used, such as that exemplified in http://www.slideshare.net/chintanajoshi/acoustic-echo-cancellation a presentation by Chintan A. Joshi of NIRMA University. Another issue is the fact that the distance between the mouth of the user and the microphone that is located on the mobile phone, varies significantly during the phone conversation. In a noisy environment this fact can significantly decrease the Signal to Noise Ratio (SNR), which can generate very poor speech quality at the far end side. In addition, the mobile handset user hears the incoming call unclearly, because he hears the incoming voice combined with ambient noise which provides poor SNR. Hence in a noisy environment a user is expected to attach the mobile phone to his ear (such as in FIGS. 3, 4) or to move the mobile phone closer to his mouth (such as in FIG. 2), in order to increase the received speech volume by bringing the speaker closer to his ear. As a side benefit also the transmitted sound level to the other part increases and the other party hears the voice with improved SNR.

In the mode where there is mid or high ambient noise and the user attaches the phone to his ear, the present invention takes advantage of the fact that the phone is in contact with the skull. The invention uses an array of standard microphones combined with bone conduction microphone and a signal processor. The processor processes all the signals that were picked up by the microphones (including the bone conduction microphones) with a process that can eliminate significantly the ambient noise that the other party hears, and if desired can completely eliminate the background noise that the other party hears.

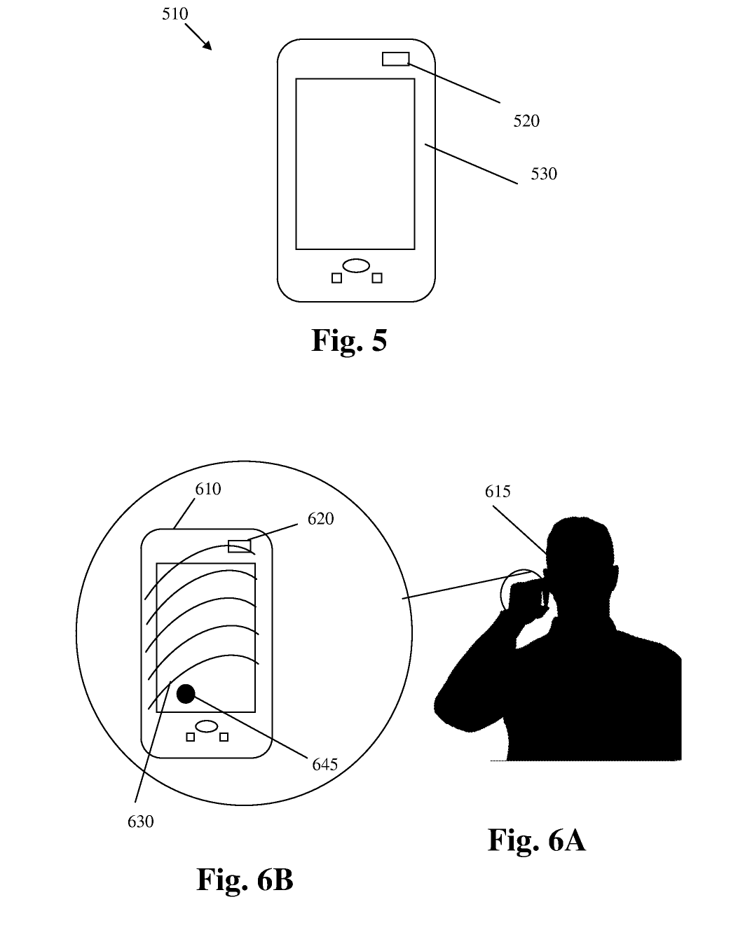

The bone conduction microphone is actually a bone vibration detector (also referred to as “bone conduction detector”). Said bone vibration detector has to be in a vibrational contact with the mobile phone's panel, and therefore it can be embedded in the mobile phone as part of the panel or behind the panel, regardless the exact location of the vibration detector, as long as there is a contact between the bone vibration detector and the panel. FIG. 5 schematically illustrates a mobile phone panel 510 in which the bone vibration detector 520 is embedded as a part of the frame of the panel 530 or behind the panel. The bone vibration detector can be positioned far away from the front panel, e.g., next to the phone battery, and it will still provide the advantages of the invention as long as it is in vibrational contact with said from panel.

In an embodiment of the invention, the bone vibration detector is utilized to detect bone vibration caused when the user is talking and the phone touches the user's skull as schematically shown in FIG. 3 or 4.

FIG. 6A shows an example where the user is talking and there is one point of contact 645 between the phone panel 610 and the user's skull 615. FIG. 6B is an enlarged view of the phone held by the user of FIG. 6A, rotated by approximately 90° relative to the working position of FIG. 6A, so as to show the front panel. The bone vibration 630 generated by the user's voice at 645, the point of contact between the user face and the panel, propagates through the panel glass to the vibration detector 620. The vibration is detected by the bone vibration detector 620 (which is a bone conduction microphone) that is embedded in, or attached to the panel or behind the panel. The picked up vibration represents the speech of the user. This information together with the information from the array of microphones, is used in order to improve the noise cancellation process. It must be noted that the vibration detector location does not necessarily have to be behind the location where the user touch his skull, it is sufficient that the vibration detector touches the panel in any location as the vibration that the panel pick propagates over the whole display panel.

In another embodiment of the invention, the vibration detector detects the user's voice when the panel has no contact with the user's skull, if the panel is close enough (e.g., below ˜30 cm) to the user′ mouth, as schematically illustrated in FIG. 2. In this case, the direct pressure caused by the speech on the panel vibrates the panel, and these vibrations are detected by the vibration detector, which is located on the panel or below the panel. If the panel is far from the user's mouth as shown in FIG. 1, the direct pressure caused by the speech on the panel is too small and no meaningful vibration is detected by said vibration detector. As will be appreciated by the skilled person the useful distance between the speakers mouth and the panel of the communication device will vary in different models of phones. However, because the invention provides for a direct feedback to the user in the form of an improved communication experience, each user will select speaking distance that provides the best performance according to his views. In this embodiment of the invention, where the user uses speaker mode and the mobile phone's panel is close enough to the user's mouth, according to the present invention the processor that oversees the various modes is configured to activate a process that reduces the noise for the other party by using a signal processor and an array of standard microphones combined with the bone vibration detector. It must be noted that although the panel doesn't touch the bone, the direct pressure caused by the speech on the panel vibrates the panel, since it is close enough to the user's mouth.

The processor processes all the signals that were picked up by the microphones (including the bone vibration microphone) with a process that can eliminate significantly the ambient noise that the other party hears, and if desired it can completely eliminate the background noise that the other party hears.

The bone vibration detector (bone conduction microphone) can be embedded in the mobile phone as part of the panel or behind the panel attached to it, for example in the battery case. As already noted above, the location of the bone vibration detector does not necessarily have to be in front of the user's mouth, it is sufficient that the bone vibration detector touches the panel in any location, as the vibration that the panel picks propagates over the whole display panel.

In another embodiment of the invention, where the user attaches the phone to his ear and closes his second ear, the invention takes advantage of the fact that the phone is attached to the skull and in addition to the use of bone vibration detector as a bone conduction microphone, the system and apparatus of the invention use a bone conduction speaker which touches the user's skull and which is embedded in the phone. The bone conduction speaker passes the incoming voice on to the user. Thus, another advantage of the system of the invention is that the standard speakers and the bone conduction speakers simultaneously deliver the incoming voice to the user, thus increasing the volume of the sound received in the ear.

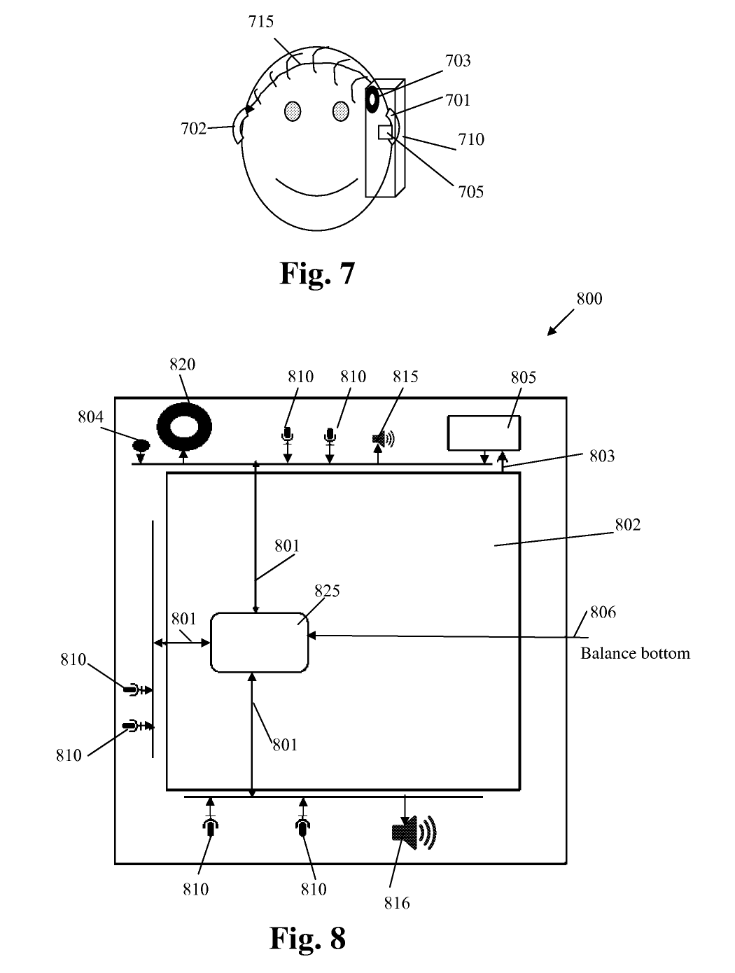

FIG. 7 schematically shows an exemplary case, in which the user attaches the mobile phone 710 to the right ear 701, and there is more than one point of contact between the mobile phone and the user's skull; hence the standard speaker 705 delivers the voice call to the user through the right side air canal of the ear. The Bone conduction speaker 703 that is also in contact with the user's right skull, works differently; it vibrates the skull and the sound wave 715 propagates through the bone to both ears 701 and 702. In this case the user hears the voice in both ears 701 and 702 although the phone is in contact only with the right side of the skull. According to one embodiment of the invention the processor analyses and processes both signals, to achieve balance between the voices that are heard in both ears. The fact that the user hears the voice in both ears improves the received voice intelligibility as both ears hear the incoming call.

In another embodiment of the invention, if the user closes the ear which is not in contact with the phone, i.e., the left side ear 702, the penetrated ambient noise decreases and due to the occlusion effect, it boosts the propagated signal to the left ear and significantly improves the SNR in this ear. As will be apparent to the skilled person, no balance can be achieved if only one source is used. Assuming the device is attached to the right side, the signal heard in the right side is much stronger than what is heard in the left side (due the attenuation of the sound through the bone), which generates an unbalanced signal; Thus, the user will hear mainly the right-ear signal. Although balance could be in principle achieved with one source, if the vibrator is located on the top of the head, forehead or on the neck, this is obviously not a practical solution for cellular phone users.

In another embodiment of the invention, as noted above, the processor automatically analyzes and recognizes the mode of operation of the mobile phone and automatically selects its own appropriate mode of operation. The processor switches between the different processes as the mode of operation is changed and uses a part or all the above microphones and/or speakers (regular and bone conduction) to achieve the best noise reduction effect.

FIG. 8 schematically shows an example of a typical structure of a mobile phone 800 according to an embodiment of the invention. The system and apparatus of the invention consist of standard multi microphones 810 that can be located in the phone in different locations. In FIG. 8, it can be seen that the mobile phone 800, comprises 6 microphones 810. However, if necessary, more microphones can be inserted and used (not shown) or only part of them. For example, only two microphones located in different locations can be used, such as the microphones at the bottom of the phone and another at the top of the phone. Alternatively, the two microphones can be located at the bottom of the phone, or one microphone can be located at the bottom of the phone and another one located at the left or right side of the phone, etc. The microphones 810 are connected to processor 825 via a digital or analog connection 801. Standard speakers 815 and 816 are fed by processor 825 via the digital or analog connection 801. Speaker 815 is used in handheld mode as earpiece speaker when the phone is in contact with the user's ear and speaker 816 is used in speaker mode. A bone vibration detector 805, which detects the vibration on the display panel 802, is embedded in the mobile phone as part of the panel 802. The vibration detector 805 can also be located behind the panel (not shown) as long as there is a vibrational contact between the panel 802 and the vibration detector 805. When the user talks and brings the phone into contact with his skull, the bone vibration generated by the user's voice passes to the phone panel 802, which vibrates accordingly, the vibration of the panel 803, is detected by vibration detector 805. The picked up vibration represents the speech of the talking person. A typical vibration detector can be made by using piezoelectric elements that are sensitive to voice vibration, or by a standard microphone covered with rubber, where the rubber touches the glass of the panel. The output of the vibration detector 805 is fed to processor 825 via the digital or analog connection 801. A proximity detector 804 is also embedded in the panel of the phone and it is used to detect if the user hold the phone close to his cheek. The proximity detector can be found in most of the mobile phones that have a touch screen panel. The output of the proximity detector 804 is fed to processor 825 via the digital or analog connection 801.

It must be noted that the vibration detector location does not necessarily have to be behind the location where the user touch his skull, it is sufficient that the skull touches the panel at any location as the vibration that the panel picks, propagates over the whole display panel.

A bone conduction speaker 820 is embedded in the phone 800 and is located at the upper part of the phone 800, so that in a handheld mode the bone conduction speaker 820 is in contact with the user's skull. The speech signal is delivered from processor 825 to the speaker 820 via digital or analog connection 801. The bone conduction speaker 820 passes incoming voice on to the user. The system of the present invention simultaneously delivers to the user the received voice from speaker 815 and from bone conduction speaker 820. Hence in a handheld mode where there is contact between the mobile phone and the user's skull, the standard speaker 815 delivers the voice call to the user through the right side air canal of the ear. The Bone conduction speaker, which also is in contact with the user's skull, vibrates the skull and the sound wave propagates through the bone to both ears. In this case the user hears the voice in both ears although the phone is in contact only with one side of the skull. The processor 825 processes both signals to achieve balance between the voices that are heard in both ears. The fact that the user hears the voice in both ears improves the received voice intelligibility as both ears hear the incoming call. In addition if the user closes the ear that is not in contact with mobile phone, the penetrated ambient noise decreases and due to the occlusion effect it boost the propagated signal through the bone to the ear that is not in contact with mobile phone, which significantly improve the SNR in this ear.

Processor 825 can be a dedicated processor that includes processing capabilities such as an ARM processor or a DSP processor, which interfaces with the connection 801. Alternatively, the processor 825 can be implemented in the application processor or in the baseband processor, which are currently found in many mobile phones.

In an embodiment of the invention the processor 825 detects the mode of operation of the user, namely in which mode out of the four following modes the user acts:
Case I. Speaker mode, where the mobile phone is far from user's mouth
Case II. Speaker mode, where the mobile phone is close to user's mouth
Case III. Handheld mode where there is contact between the user's ear, the user's skull and the phone
Case IV. Handheld mode where there is contact between the user's ear, the user's skull and the phone, and simultaneously the other user's ear is closed with the user's hand or by other means;

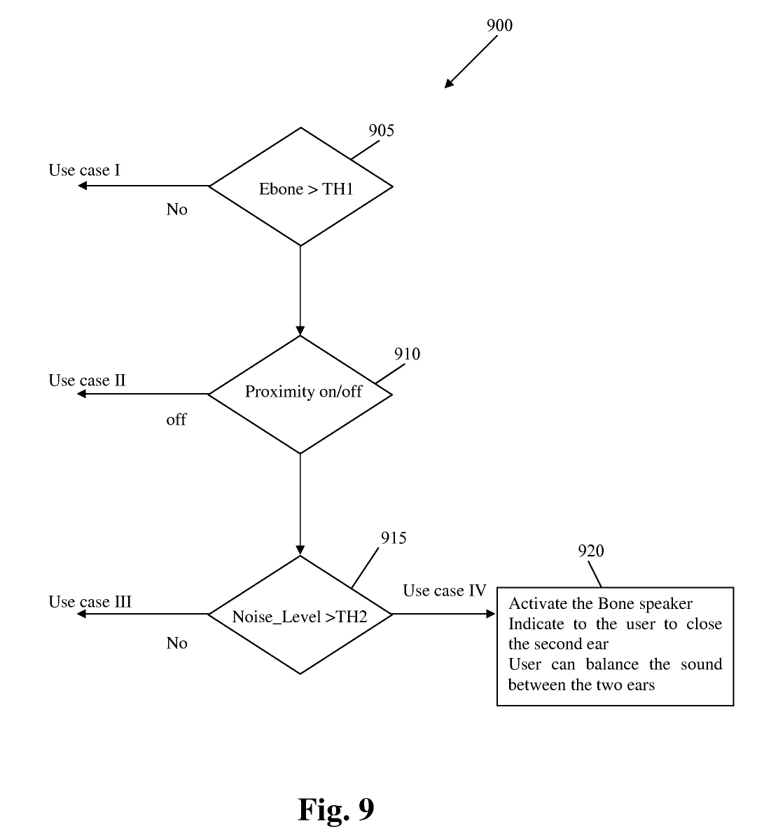

Once the mode of operation is detected, the processor performs a process that is appropriate for the detected mode. There are different ways to identify the user's mode of operation, for example: processor 825 analyzes two signals: the output of the vibration detector 805 and of the proximity detector 804. One can consider also to use the indication from the application processor, whether the user is in speaker mode or handheld mode, however there are some cases for voice command applications that this indication is not necessary available. In the current example only the output of the vibration detector 805 and of the proximity detector 804 are used, which are fed to processor 825 via connection 801. The proximity detector 804 is used to detect if the user holds the phone close to his cheek. If the phone is held close to the user's cheek, it means that the phone is used in a handheld mode and so the panel is shut down during this mode of operation in order to save power. The processor uses this information as described in FIG. 9.

FIG. 9 is a schematic flow chart of the method according to one embodiment of the invention. Method 900 is activated when a user operates a voice communication in the mobile phone. In the first step 905, the signal Energy-bone(n), which is the energy of the bone signal received from the vibration detector 805, is filtered by a low pass filter such as

Ebone(n)=Alpha*Ebone(n−1)+(1−alpha)*Energy-bone(n)

If the result Ebone(n) is smaller than a predefined threshold TH1, it means that no bone signal is detected, namely the phone is far from the user's mouth, which means that the mode of use is speaker mode of “Case I”. In this case the mode of use was detected. However, if the result Ebone(n) is bigger than a predefined threshold, it means that the bone vibration detector detects a voice of a talking person. In that case the mode of use is not detected since it can be “Case II”, “Case III” or “Case IV”, and therefore step 910 is carried out. In step 910, the proximity criteria are checked. If the proximity criteria are off, it means that the phone is not in contact with the user's face. Hence the mode of use detected at this step is speaker mode of “Case II”. If the proximity criteria are on, step 915 is carried out. In step 915 the proximity is on and therefore it means that the mode of use is either “Case III” or “Case IV”. If the environmental noise level “Noise_Level” is below a predefined threshold TH2 it means that the noise is not too high, and the user doesn't have to close his unused ear. In that case, the detected mode of use is “Case III”. If Noise_Level is bigger than the predefined threshold TH2, it means that the user is in a high noise environment, and then the system activates the bone speaker, and indicates that it has been activated, e.g., by a vocal prompt or by a short beep, suggesting closing the second ear. In addition the system provides to the user the ability to balance the sound between the two ears by using balance control button 806.

In each mode of operation a different noise cancellation technique is used, based on the case use. Examples for typical processes in each case are described below. It must be noted that the invention is by no means limited to the specific, illustrative techniques described herein, and one can use different techniques as well.

### Example of Case I Process

“Case I” is a standard speaker mode, where the mobile phone is far from the user's mouth. In this case it is assumed that the ambient noise is very low, hence the processor 825 activates one microphone 810, which is located at the bottom of the phone 800, in addition to some standard echo cancellation process that is performed to eliminate echo generated by the speaker. It should be noted that a different number of microphones 810 can be activated—for example, two microphones or more. Also standard Noise cancellation techniques can be performed.

### Example of Case II Process

Case II, is a standard speaker mode, where the mobile phone is close to the user's mouth. For this mode it is assumed that the ambient noise level is in the range of low to medium noise level. In this case the user speaks in speaker mode but holds the phone close to his mouth in order to overcome the environmental noise and to be able to hear the incoming call via the speaker. According to one embodiment of the invention, the processor uses two or more microphones 810 located in different location in the phone, as well as the bone vibration detector 805 that detects the voice vibration on the display panel 802 of the phone. When the user talks and his mouth is close to the display panel of the phone, the vibration generated by the user's voice passes to the phone panel, which vibrates accordingly. This vibration is detected by vibration detector 805 that is embedded in the phone or attached to the panel. The picked-up vibration represents the speech of the talking person. It should be noted that sensor 805 is sensitive to the user's vibration and much less to the ambient noise. Without attempting to provide a full explanation of this fact, which has been experimentally determined, it is believed that it may be mainly due to the fact that only waves that hit the phone's panel perpendicularly create a substantial vibration, which is picked up by the vibration detector. In most cases significant part of the ambient noise does not perpendicularly impinge on the phone's panel hence the amount of noise the vibration detect is significant smaller compared to the total noise.

In this mode the user might change the phone position relative to the user's mouth during the phone call. When the phone is close enough to the user's mouth the voice level detected by 805 is strong and its energy Ebone is bigger than the predefined threshold Th1. If during the call the user changes the phone location to be far from the mouth, the energy Ebone decreases and it can get below the threshold Th1. This is not desired in noisy environment. In order to eliminate such a situation, in one embodiment of the invention the processor 825 provides a notification to the user how far is the mobile phone from the mouth. The indication can be by voice annotation during the call, or alternatively the processor can forward a command to the panel controller to display a bar that indicates to the user the strength of the energy Ebone. This indication acts as a feedback to the user and indicates to the user if the phone distance from his mouth meets the desired distance.

If the user holds the mobile phone far from his mouth and despite said visual or audio indication doesn't change the phone location, in this particular embodiment of the invention the system is configured to automatically recognize a new mode of use and thus automatically switches and adjusts to handle the user's mode of use as Case I.

An example of noise cancellation for the transmitted voice with the use of two standard microphones 810 and a bone vibration detector 805 can be formulated by the following equations:

The signal that is detected in the standard two microphones M₁(n) and M₂(n) can be described by:

M₁(n)=s(n)+d(n)+n₁(n)

M₂(n)=α(n)*s(n)+β(n)*d(n)+n₂(n)

where:
s(n) is the speech produced by the near end user;
d(n) is the ambient noise in the near end;
n₁(n) n₂(n) is noise of the pickup equipment;
α(n) is the filter that the speech undergoes relative to m1;
β(n) is the filter that the noise undergoes relative to m1; and
* represent convolution;

A typical vibration detector such as 805 is sensitive to the user's vibration up to some voice frequencies, and much less to the ambient noise. Hence the vibration detector 805 (i.e. the bone conduction microphone) signal M₃(n), can be described as follows:

M₃(n)=χ(n)*s(n)+n₃(n)

where χ(n) is a low pass filter that models the vibration sensor characteristics and n₃(n) is noise of the vibration sensor.

Hence:

M₁(n)=s(n)+d(n)+n1(n)

M₂(n)=α(n)*s(n)+β(n)*d(n)+n₂(n)

M₃(n)=χ(n)*s(n)+n₃(n)

According to this particular embodiment of the invention the target is to estimate the original speech s(n) and the ambient noise d(n) which are denoted as Ŝ(n) and \hat{d}(n) respectively.

Ŝ(n) is the “clean speech” signal that is transmitted to the far end user.

s(n) can be estimated by various known MMSE (Minimum Mean Square Error) technique.

One alternative for calculating Ŝ(n) and \hat{d}(n) is as follows:

First Ŝ(n) is estimated by:

\hat{S}(n)=h₁(n)*M₁(n)+h₂(n)*M₂(n)+h₃(n)*M₃(n);

e(n) represents the estimation error, namely:

e(n)=\hat{S}(n)−s(n)

Hence the mean square error J is

J=E(e²)

J=E{[h₁(n)*M₁(n)+h₂(n)*M₂(n)+h₃(n)*M₃(n)−s(n)]²}

E{ } is the mean operator

### Hence:

∂J/∂hᵢ=2e(n)Mᵢ(n)

where i=1, 2, 3

Following the above equations, h1(n), h2(n) and h3(n) can be calculated by LMS adaptation process:

hᵢ(n+1)=hᵢ(n)+μ·e*(n)·Mᵢ(n)

where i=1, 2, 3

It should be noted that during the adaptation process there is a period of time during which the near-end user is silent, namely s(n)=0. During this period of time one of the filters (e.g. h1(n)) needs to be frozen, otherwise the adaptation ends up with h1(n)=h2(n)=h3(n)=0, which is an undesired solution.

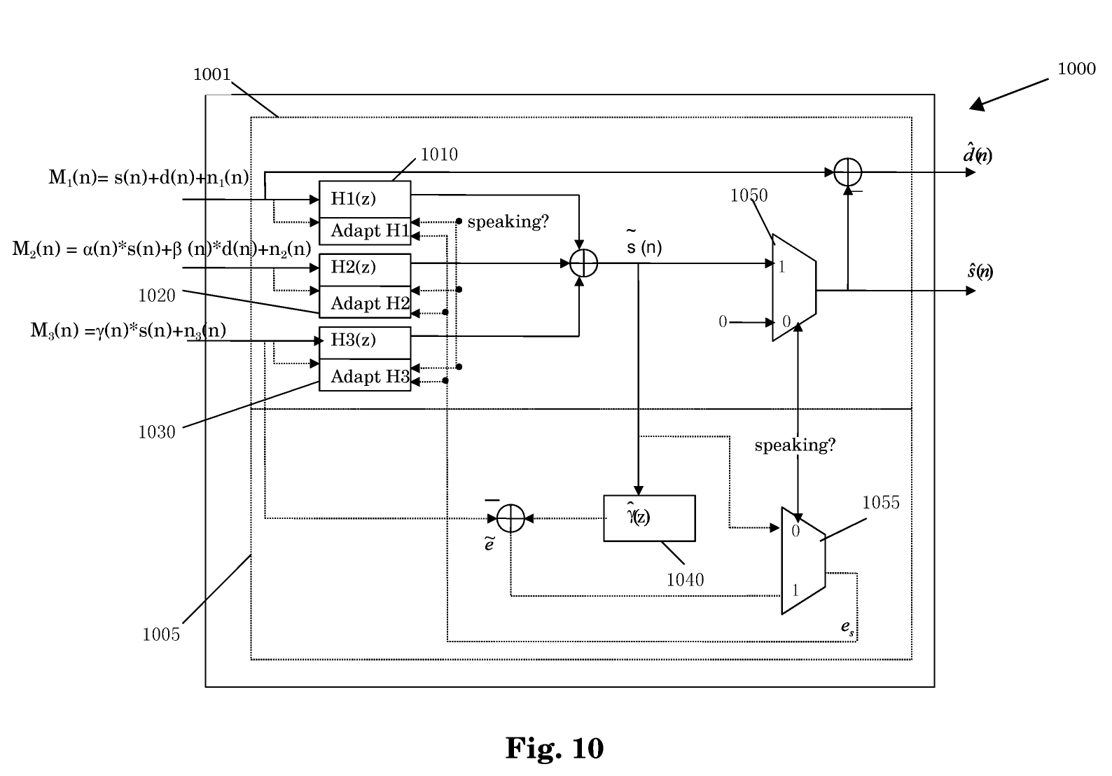

FIG. 10 schematically describes the system, which estimates the original speech s(n) and the ambient noise d(n). System 1000 consists of two main blocks 1001 and 1005. 1001 estimates the signal s(n) and d(n) denoted as ŝ(n) and \hat{d}(n). 1005 is the block that updates the values of the filters h1(n), h2(n), h3(n).

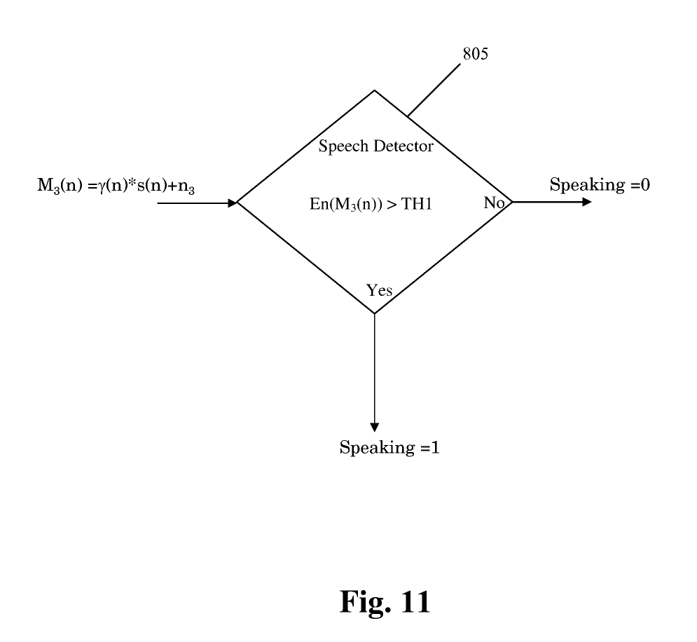

M1(n) is fed to 1010, M2(n) is fed to 1020 and M3(n) is fed to 1030, the sum of the three filters output is \tilde{s}(n), where Hₖ(z) is the Z transform of hₖ(n), k=1, 3. Mux 1050 chooses the final estimation of ŝ(n), according to the processed frame. In the case that it is a speech frame ŝ(n)=\tilde{s}(n), otherwise ŝ(n)=0. The decision if a frame is a speech or a silence frame is calculated as described in FIG. 11.

The adaptation process is based on ∂J/∂hᵢ=2e(n)Mᵢ(n), i=1, 2, 3, hence the estimation errors need to be calculated.

The appropriate error is chosen by mux 1055. In a speech frame the error is calculated by using filter 1040 and is

\tilde{e}(n)≈\hat{γ}(n)*\tilde{s}(n)−M₃(n);

In a silence frame, the error signal is \tilde{s}(n)

It must be noted that the switch of speech/silent frame, can also be used to change the adaptation weights (step size) in 1010, 1020, 1030. All the process of 1000 can be implemented in the processor 825.

To avoid adaptation at silence a speech detection mechanism is used. FIG. 11 shows a schematic flow chart which describes an example of a speech detection mechanism. The vibration detector 805 detects the signal M₃(n) every speech frame of T ms., M₃(n) is combined of the low pass version of speech signal and the inherent noise n3(n) of the vibration sensor. The detector 805 is sensitive to the low pass version of speech signal but it is barely sensitive to the ambient noise, so that the ambient noise which is detected by the detector 805 is negligible. Hence, by comparing the energy of M₃(n) to a predefined threshold TH1 it can be decided if the user is speaking or not. If the energy of M₃(n) is above TH1, then the detector 805 declares that there is a speech signal and the output is 1. Else if the energy of M₃(n) is lower than TH1, then there is no speech signal and the output is 0. Other mechanisms known to the person skilled in the art can also be used. This process can be implemented by processor 825.

In most cases the talking user, who is talking in a noisy environment and whose mobile phone's apparatus operates a noise reduction process, has no indication of the amount of noise that was reduced, or of how much his transmitted voice is clean from ambient noise. The present invention, in one embodiment, uses the error estimate e(n) as an indication of the amount of noise that was reduced. This information can be used as a visual indication to be displayed on the mobile phone panel, for example by some bars. A full bar indicates a good cancellation and a small bar indicates a poor cancellation. Alternatively an audible indication can also be used.

### Example of Case III Process

This case is a regular mode where the user attaches the phone to one of his ears and where the ambient noise level is in the range of mid to high noise level, or there is no noise but the user prefers to use this mode. In case of mid to high noise level, the user attaches the phone to one of his ears in order to increase the incoming sound level as well as to increase the voice level of the talking person relative to the ambient noise level, and in order to reduce the noise effect for the other party.

As an example of this case, in one embodiment of the invention processor 825 uses two microphones 810 located at different location in the phone, as well as the vibration detector 805. When the user talks and brings the phone into contact with his skull, the bone vibration generated by the user's voice passes to the phone panel, which vibrates accordingly. This vibration is detected by vibration detector 805 that is embedded in the panel or is in contact with the panel 802. The picked-up vibration represents the speech of the talking person. It must be noted that detector 805 is sensitive to the user's vibration and much less to the ambient noise. Processor 825 is configured to process those three signals in a manner which is similar to the way used in “Case II”, with different adaptation parameters.

### Example of Case IV Process

This case is a regular mode where the user hears high ambient noise level and so attaches the phone to one of his ears and simultaneously closes the other ear with his hand or with other means. In this case the present invention uses an array of standard microphones 810 combined with bone conduction microphone, i.e. the vibration detector 805, the bone conduction speaker 820, and a signal processor 825. The processor cancels the noise for the far end user. The processor also improves the intelligibility of the received call. For the noise cancellation, the processor uses the array of the standard microphones 810 combined with the vibration detector 805 and the process is the same as described in case III above, where some of the parameter are tuned for high level ambient noise.

For the improvement of the intelligibility of the received call, the processor activates in addition to said standard speaker 815, the bone conduction speaker 820, which is embedded in the mobile phone so that it is in contact with the user's skull.

The bone conduction speaker passes the incoming voice to the user. In the system of the invention, the standard speaker 815 and the bone conduction speaker 820 simultaneously deliver the incoming voice to the user. When the user attaches his phone to one of his ears, the standard speaker delivers the incoming voice call to the user through the side air canal of said ear. The bone conduction speaker 820 that is also attached to the user's skull works differently—it vibrates the skull and the sound wave propagates through the bone to both ears. In this case the user hears the voice in both ears, although the phone is attached only to the right side. According to an embodiment of the invention the processor processes both signals to achieve balance between the voices that is heard in both ears. The fact that the user hears the voice in both ears improves the received voice intelligibility, as both ears hear the incoming call. In addition, when the user closes the ear which is not in contact with the phone, the penetrated ambient noise to said ear decreases and due to the occlusion effect it boost the propagated incoming voice signal to said ear and therefore significantly improves the SNR in the ear which is not in contact with the phone.

A typical process operated by the processor in order to balance between the two ears is described as follows:

Since both speakers 815 and 820 are in contact with one side of the skull, and due to the fact that the received voice is injected to the user by the standard speaker 815 and bone conduction speaker 820, said side which is in contact with the phone hears the signal Sr(n) which is the sum of the standard microphone voice signal and the bone conduction voice signal, namely:

Sr(n)=Ar(n)*S(n)+Br(n)*S(n);

where Bl(n) and Br(n) are the attenuation filter, that voice signal s(n) undergo while propagating from the contact point on the bone to the left and right sides of the user ears. Assuming that Br(n) and Bl(n) are constant over all the frequency band, namely, Br(f)=Br and Bl(f)=Bl. f denote frequency
Ar is adjustable gain of the standard speaker that can be used to balance between the volumes of the two ears.

Sl(n) is the incoming voice signal heard in the ear which is not in contact with the mobile phone, due the voice signal s(n) injected by the bone and propagated from the contact point on the bone in the side which is in contact with the mobile phone to the ear which is not in contact with the mobile phone, and so:

Sl(n)=Bl(n)*S(n)

Due to the fact that the user closes his ear which is not in contact with the mobile phone, than the propagated bone signal which arrives to the ear that is not in contact with the mobile phone, is boosted by gain Go, this boost is well known in the art and is called occlusion effect.

Hence

Sl(n)=GoBl(n)*S(n)

In order that the two ears hear the sound in the same level, Ar should be chosen to meet the following equation

ArS(f)+BrS(f)=GoBlS(f)

namely

Ar=GoBl−Br

Bl and Br are parameters that depend on the user's bone conduction of sound, hence to generate the balance it can be measured during a calibration process, or alternatively a balance key 806 is added to the system, which allows the user to change the balance to a point that he hears in both ear the same volume.

It must be noted that in Case IV, when the bone conduction speaker and the bone conduction microphone are activated simultaneously, the bone conduction microphone detects the bone speaker signal, which might affect the quality of the bone conduction microphone. To reduce said effect of the bone conduction speaker, a standard echo cancellation technique is operated between the known bone conduction speaker signal and the bone conduction microphone signal which picks the sum of the user's voice and the bone conduction speaker signal.

Although embodiments of the invention have been described by way of illustration, it will be understood that the invention may be carried out with many variations, modifications, and adaptations, without exceeding the scope of the claims.

1. A mobile communication device having a body that houses electronic components and a front panel comprising a display, said mobile communication device further comprising at least one standard microphone and a vibration sensor located in vibrational connection with the front panel of the device.

2. A mobile communication device according to claim 1, further comprising a bone conduction speaker.

3. A mobile communication device according to claim 1, wherein the vibration sensor is attached to the front panel.

4. A mobile communication device according to claim 1, comprising a processor configured to operate differently as a result of a determination that the user of the mobile communication device is operating it in one of the following modes:
i) a “Speaker Mode” with the device far from the user's mouth;
ii) a “Speaker Mode” with the device close to the user's mouth;
iii) a “Handheld Mode” with the device in contact with one of the user's ear;
iv) a “Handheld Mode” with the device in contact with one of the user's ear while the second ear is closed.

5. A mobile communication device according to claim 4, wherein the mode is i) and the processor activates one or more standard microphones.

6. A mobile communication device according to claim 4, wherein the mode is ii) or iii) and the processor activates two or more standard microphones located at two different locations in the communication device, and further operates a vibration detector positioned so as to detect vibration generated by the user's voice on the device's panel.

7. A mobile communication device according to claim 5, wherein the mode is iv) and the processor activates two or more standard microphones, a vibration detector and a bone conduction speaker.

8. A mobile communication device according to claim 1, wherein when the bone conducting speaker is activated the processor is configured to balance the signal transmitted to the ears so as to provide to the user a voice of approximately the same intensity in both ears.

9. A mobile communication device according to claim 1, which is provided with an indicator suitable to alert the user that the phone is located at a distance from his mouth that is greater than a predetermined value.

10. A mobile communication device according to claim 9, wherein the indicator provides an acoustic signal.

11. A mobile communication device according to claim 9, wherein the indicator provides a visual signal.

12. A mobile communication device according to claim 1, which is provided with a noise reduction indicator suitable to provide an indication to the user of the level of noise reduction that a conversation is enjoying.

13. A method for operating a mobile communication device having a body that houses electronic components and a front panel comprising a display, said mobile communication device further comprising at least one standard microphone and a vibration sensor located in vibrational connection with the front panel of the device, the method comprising providing a processor configured to operate differently as a result of a determination that the user of the mobile communication device is operating it in one of the following modes:
i) a “Speaker Mode” with the device far from the user's mouth;
ii) a “Speaker Mode” with the device close to the user's mouth;
iii) a “Handheld Mode” with the device in contact with one of the user's ear;
iv) a “Handheld Mode” with the device in contact with one of the user's ear while the second ear is closed.

14. A method according to claim 13, wherein the mode is i) and the processor activates one or more standard microphones.

15. A method according to claim 13, wherein the mode is ii) or iii) and the processor activates two or more standard microphones located at two different locations in the communication device, and further operates a vibration detector positioned so as to detect vibration generated by the user's voice on the device's panel.

16. A method according to claim 13, wherein the mode is iv) and the processor activates two or more standard microphones, a vibration detector and a bone conduction speaker.
